(19) United States
(12) Patent Application Publication
(10) Pub. No.: US 2023/0043933 A1
(43) Pub. Date: Feb. 9, 2023

(54) METAL DEPOSITION-BASED STRECHABLE ELECTRODE USING ELECTROSPUN MAT AND MANUFACTURING METHOD THEREFOR

(71) Applicant: POSTECH Research and Business Development Foundation, Pohang-si, Gyeongsangbuk-do (KR)

(72) Inventors: Unyong Jeong, Pohang-si, Gyeongsangbuk-do (KR); Sungmin Moon, Buk-gu, Daegu (KR)

(21) Appl. No.: 17/772,580

(22) PCT Filed: Oct. 5, 2020
(86) PCT No.: PCT/KR2020/013441

§ 371 Date: May 25, 2022

(30) Foreign Application Priority Data
Oct. 29, 2019 (KR) 10-2019-0135233

(51) Int. Cl. H01B 5/14; H01B 13/00; H01B 5/16; H01B 1/22; C08L 79/02; D01D 5/00

(52) U.S. Cl. CPC H01B 5/14; H01B 13/0026; H01B 5/16; H01B 1/22; C08L 79/02; D01D 5/003

(57) ABSTRACT

A metal deposition-based stretchable electrode using an electrospun mat and a manufacturing method therefor are disclosed. The stretchable electrode is a stretchable electrode comprising a conductive mat, wherein the conductive mat comprises: nanofibers including a polymer; and a conductive layer formed on the surface of the nanofibers and including a conductor. The stretchable electrode has air/fluid permeability and may have conductivity that exhibits a stable change even in a biaxial deformation environment.

### TECHNICAL FIELD

The following description relates to a stretchable electrode which may be used as a wearable electronic device material or a body-attached type or body-organ-attached type electrode material, and a method of manufacturing the same.

### BACKGROUND ART

A stretchable electronic device has attracted attention in the past decade as a promising next-generation electronic device, and artificial skin, health monitoring and implantable medical devices are the most promising applications for the stretchable electronic device. The application requires biaxial stretchability to accommodate multi-axial body movements (skin torsion, joint rotation, contraction and expansion of organs) and air/fluid permeability to prevent skin irritation and ensure long-term use.

Among various device components, a stretchable electrode is a basic component of the stretchable electronic device. An existing stretchable electrodes were manufactured by forming a conductive layer on a stretchable elastomer substrate in the form of a film using a metal ink printing method. However, the use is limited since such method restricts the permeation of air/fluid for use in attachable devices.

Therefore, a study on a stretchable electrode having conductivity exhibiting a stable change compared to initial resistance even in a biaxial deformation environment and securing air/fluid permeability, and a method of manufacturing the same is needed.

### DISCLOSURE OF THE INVENTION

### Technical Goals

An aspect provides a stretchable electrode having air/fluid permeability, and conductivity exhibiting a stable change even in a biaxial deformation environment to solve the above issues.

Another aspect provides a stretchable electrode capable of preventing foreign body sensation, skin rash, and the like, when used as a wearable electronic device through air/fluid permeability, and a method of manufacturing the same.

Another aspect provides a stretchable electrode capable of permeating various fluids such as electrolyte and blood in the body, and having high durability due to the possibility of electrode deformation even when attached to organs that change in volume, such as heart and bladder, and a method of manufacturing the same.

### Technical Solutions

According to an aspect, there is provided a stretchable electrode including a conductive mat, wherein the conductive mat includes nanofibers including a polymer, and a conductive layer formed on surfaces of the nanofibers and including a conductor.

Further, the stretchable electrode may further include a base mat on the conductive mat, and the base mat may include nanofibers including a polymer.

Further, the conductive mat and the base mat may each independently further include a polyalkyleneimine obtained by crosslinking the polymer.

Further, the crosslinking may each independently include at least one selected form a group consisting of inter-crosslinking which crosslinks surfaces of nanofibers with each other and intra-crosslinking which crosslinks the polymer within a single nanofiber.

Further, the conductive mat and the base mat may be bonded, wherein the bonding may be by at least one selected from a group consisting of sharing of a part of the polymer of the conductive mat and a part of the polymer of the base mat, and crosslinking between the polymer of the conductive mat and the polymer of the base mat.

Further, the polyalkyleneimines may be the same or different from each other, and may each independently include at least one selected from a group consisting of linear polyalkyleneimine, comb polyalkyleneimine, branched polyalkyleneimine, and dendrimer polyalkyleneimine.

Further, the polyalkyleneimines may be the same or different from each other, and may each independently include at least one selected from a group consisting of polyethyleneimine and polypropyleneimine.

Further, the polymer may be an elastic body.

Further, the polymers may be the same or different from each other, and may each independently include at least one selected from a group consisting of styrene-butadiene-styrene block copolymer (SBS), styrene-isoprene-styrene block copolymer (SIS), styrene-ethylene-butylene-styrene block copolymer (SEBS), styrene-butadiene block copolymer (SBR), styrene-ethylene-propylene-styrene block copolymer (SEPS), styrene-methyl methacrylate copolymer (PSMMA), styrene-acrylonitrile copolymer (PSAN), polyurethane, silicone rubber and butadiene rubber.

Further, the polymer may further include an organic acid anhydride grafted to a main chain.

Further, the organic acid anhydride may include at least one selected from a group consisting of maleic anhydride, succinic anhydride, acetic anhydride, Naphthalenetetracarboxylic dianhydride, and ethanoic anhydride.

Further, the conductor may include at least one selected from a group consisting of gold, silver, copper, platinum palladium, nickel, indium, aluminum, iron, rhodium, ruthenium, osmium, cobalt, molybdenum, zinc, vanadium, tungsten, titanium, manganese, chromium, graphene, and carbon nano tube (CNT).

Further, a thickness of the conductive mat may be 0.01 to 100 μm, and a thickness of the base mat may be 0.1 to 1000 μm.

Further, each of the conductive mat and the base mat may be porous.

According to another aspect, there is provided a method of manufacturing a stretchable electrode including (a) preparing a porous mat including a polymer crosslinked with a polyalkyleneimine by supporting, swelling, and crosslinking a porous mat including nanofibers including a polymer in a polyalkyleneimine solution, and (b) depositing a conductor to a predetermined depth of the porous mat to form a conductive layer on surfaces of nanofibers.

Further, the method of manufacturing a stretchable electrode may further include, prior to (a), (a′) electrospinning a polymer solution including the polymer to prepare the porous mat including the nanofibers.

Further, the polymer solution may further include at least one selected from a group consisting of an aprotic polar solvent and a non-polar solvent.

Further, the polyalkyleneimine solution may further include a protic polar solvent.

Further, the deposition may be performed by at least one selected from a group consisting of sputtering, thermal evaporation, e-beam evaporation, thermal chemical vapor deposition, plasma enhanced chemical vapor deposition, atmospheric pressure chemical vapor deposition and low pressure chemical vapor deposition.

Further, the predetermined depth may be controlled by adjusting a deposition time.

According to another aspect, there is provided a stretchable electronic device including the stretchable electrode.

### Advantageous Effects

A stretchable electrode according to example embodiments may have air/fluid permeability, and conductivity exhibiting a stable change even in a biaxial deformation environment.

Further, the stretchable electrode according to example embodiments may prevent foreign body sensation, skin rash, and the like, when used as a wearable electronic device through air/fluid permeability.

Furthermore, the stretchable electrode according to example embodiments may permeate various fluids such as electrolyte and blood in the body, and have high durability due to the possibility of electrode deformation even when attached to organs that change in volume, such as heart and bladder.

### BRIEF DESCRIPTION OF DRAWINGS

Since the drawings are for reference in describing exemplary embodiments, the technical spirit of the present disclosure should not be construed as limited to the accompanying drawings.

FIG. 1A is a diagram illustrating crosslinking and imidization process of a nanofiber mat according to an example embodiment.

FIG. 1B is a diagram illustrating a result of molecular weight measurement of Preparation Example 1 and Preparation Example 5.

FIG. 1C is a diagram illustrating a Stress-Strain graph upon uniaxial tension of Preparation Example 1 and Preparation Example 2.

FIG. 1D is a diagram illustrating a Stress-Strain graph upon uniaxial tension of Preparation Example 5 and Preparation Example 6.

FIG. 2A is a diagram illustrating an average diameter of nanofibers in a nanofiber mat of Preparation Example 1.

FIG. 2B is a diagram illustrating an average diameter of nanofibers in a nanofiber mat of Preparation Example 5.

FIG. 3 is a diagram illustrating a result of FT-IR analysis of Preparation Example 1, Preparation Example 5 and PEI.

FIG. 4 is a diagram illustrating a graph of Young's modulus values of Preparation Examples 1 to 8.

FIG. 5A is a diagram illustrating a result of mechanical behavior analysis through FEM simulation of Preparation Example 1.

FIG. 5B is a diagram illustrating a result of mechanical behavior analysis through FEM simulation of Preparation Example 5.

FIG. 6A is a diagram illustrating an SEM image of Comparative Example 1 upon biaxial tension.

FIG. 6B is a diagram illustrating an SEM image of Example Embodiment 1 upon biaxial tension.

FIG. 6C is a diagram illustrating a simulation of Au cracking upon biaxial tension of Comparative Example 1.

FIG. 6D is a diagram illustrating a simulation of Au cracking upon biaxial tension of Example Embodiment 1.

FIG. 7A is a diagram illustrating a cross-sectional SEM image of Example Embodiment 1.

FIG. 7B is a diagram illustrating a cross-sectional SEM image of Example Embodiment 2.

FIG. 7C is a diagram illustrating a result image when Comparative Example 1 was peeled off with a scotch tape.

FIG. 7D is a diagram illustrating a result image when Example Embodiment 1 was peeled off with a scotch tape.

FIG. 8A is a diagram illustrating images of Example Embodiment 3 and Example Embodiment 4.

FIG. 8B is a diagram illustrating images of Example Embodiment 3 and Example Embodiment 4 upon biaxial tension.

FIG. 8C is a diagram illustrating a result of a conductivity change measurement during biaxial tension of Example Embodiment 3.

FIG. 8D is a diagram illustrating a result of a conductivity change measurement during biaxial tension of Example Embodiment 4.

FIG. 8E is a diagram illustrating a result of a conductivity change measurement when the biaxial tension of Example Embodiment 3 was repeated 1,000 times and deformed.

FIG. 8F is a diagram illustrating a result of a conductivity change measurement when the biaxial tension of Example Embodiment 4 was repeated 1,000 times and deformed.

### BEST MODE FOR CARRYING OUT THE INVENTION

Hereinafter, example embodiments will be described in detail with reference to the accompanying drawings for those of ordinary skill in the art to easily carry out.

However, it should be understood that these example embodiments are not construed as limited to the illustrated forms, and when it is determined that a detailed description of a related art may obscure the gist of the present disclosure in describing example embodiments, the detailed description will be omitted.

The terminology used herein is for the purpose of describing particular example embodiments only and is not to be limiting of the example embodiments. The singular forms herein include plural forms unless the context clearly dictates the singular. As used herein, it should be understood that the terms such as “comprise”, “have”, etc. are intended to indicate the presence of features, steps, operations, components, or combinations thereof, and not to exclude the possibility of the presence of features, steps, operations, components, or combinations thereof.

In addition, although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

In addition, when it is mentioned that one component is “formed” or “stacked” on another component, it may be understood that the one component may be formed or stacked by being directly attached to the front surface or one surface on the surface of another component, still other component may be present therebetween.

Hereinafter, a metal deposition-based stretchable electrode using the electrospinning mat and a method of manufacturing the same according to example embodiments will be described in detail. However, it should be understood that these example embodiments are not construed as limited to the illustrated forms, and the scope of the disclosure is defined by the scope of the claims below.

According to an example embodiment, there is provided a stretchable electrode including a conductive mat, wherein the conductive mat includes nanofibers including a polymer, and a conductive layer formed on surfaces of the nanofibers and including a conductor.

Further, the stretchable electrode may further include a base mat on the conductive mat, and the base mat may include nanofibers including a polymer.

Further, the conductive mat and the base mat may each independently further include a polyalkyleneimine obtained by crosslinking the polymer.

Further, the crosslinking may each independently include at least one selected form a group consisting of inter-crosslinking which crosslinks surfaces of nanofibers with each other and intra-crosslinking which crosslinks the polymer within a single nanofiber.

Further, the conductive mat and the base mat may be bonded, wherein the bonding may be by at least one selected from a group consisting of sharing of a part of the polymer of the conductive mat and a part of the polymer of the base mat, and crosslinking between the polymer of the conductive mat and the polymer of the base mat.

Further, the polyalkyleneimines may be the same or different from each other, and may each independently include at least one selected from a group consisting of linear polyalkyleneimine, comb polyalkyleneimine, branched polyalkyleneimine, and dendrimer polyalkyleneimine, and preferably include branched polyalkyleneimine.

Further, the polyalkyleneimines may be the same or different from each other, and may each independently include at least one selected from a group consisting of polyethyleneimine and polypropyleneimine, and preferably include polyethyleneimine.

Further, the polymer may be an elastic body.

Further, the polymers may be the same or different from each other, and may each independently include at least one selected from a group consisting of styrene-butadiene-styrene block copolymer (SBS), styrene-isoprene-styrene block copolymer (SIS), styrene-ethylene-butylene-styrene block copolymer (SEBS), styrene-butadiene block copolymer (SBR), styrene-ethylene-propylene-styrene block copolymer (SEPS), styrene-methyl methacrylate copolymer (PSMMA), styrene-acrylonitrile copolymer (PSAN), polyurethane, silicone rubber, and butadiene rubber, and preferably include styrene-ethylene-butylene-styrene block copolymer (SEBS).

Further, the polymer may further include an organic acid anhydride grafted to a main chain.

Further, the organic acid anhydride may include at least one selected from a group consisting of maleic anhydride, succinic anhydride, acetic anhydride, Naphthalenetetracarboxylic dianhydride, and ethanoic anhydride, and preferably include maleic anhydride.

Further, the conductor may include at least one selected from a group consisting of gold, silver, copper, platinum palladium, nickel, indium, aluminum, iron, rhodium, ruthenium, osmium, cobalt, molybdenum, zinc, vanadium, tungsten, titanium, manganese, chromium, graphene, and carbon nano tube (CNT), and preferably include gold.

Meanwhile, when the surfaces of the graphene and carbon nanotubes are functionalized with NH₂ functional groups, they may be coupled with the organic acid anhydride to form a stable conductive layer.

Further, a thickness of the conductive mat may be 0.01 to 100 μm, preferably 0.5 to 50 μm, and more preferably 0.7 to 10 μm. When the thickness of the conductive mat is less than 0.01 μm, this is not preferable because it is difficult to secure conductivity due to the thickness of the thin conductive layer, and when more than 100 μm, this is not preferable because the overall elasticity of the mat is inhibited by the thick thickness of the conductive layer.

Further, a thickness of the base mat may be 0.1 to 1000 μm, preferably 10 to 500 μm, and more preferably 50 to 100 μm. When the thickness of the base mat is less than 0.1 μm, this is not preferable because the fiber is damaged in a swelling process by a protic polar solvent (ethanol) and it is difficult to maintain the shape of the mat, and when more than 1,000 μm, this is not preferable because the protic polar solvent cannot permeate deep into the mat due to the excessively thick thickness and the mat cannot be sufficiently swollen.

Further, each of the conductive mat and the base mat may be porous. As each of the conductive mat and the base mat is porous, it is possible to manufacture a stretchable electrode having air/fluid permeability.

According to an example embodiment, there is provided a method of manufacturing a stretchable electrode including (a) preparing a porous mat including a polymer crosslinked with a polyalkyleneimine by supporting, swelling, and crosslinking a porous mat including nanofibers including a polymer in a polyalkyleneimine solution, and (b) depositing a conductor to a predetermined depth of the porous mat to form a conductive layer on surfaces of nanofibers.

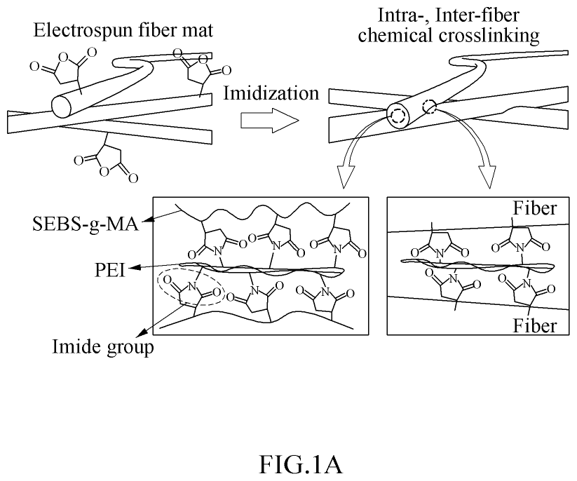

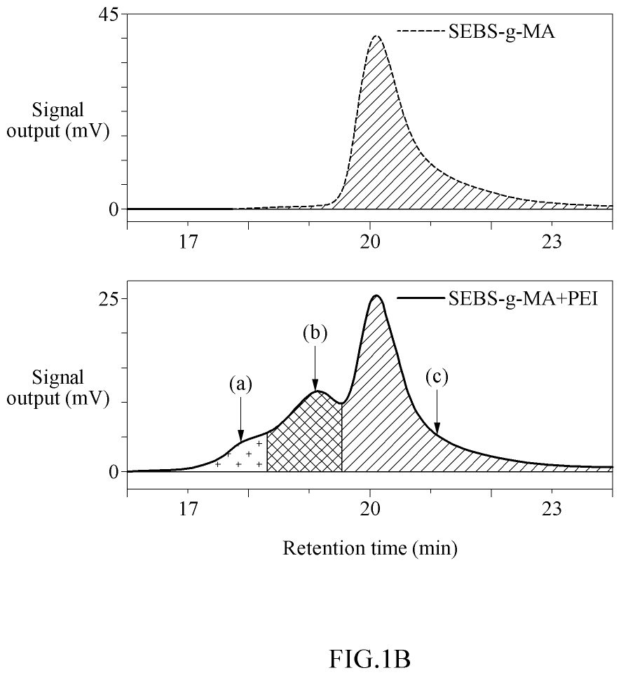

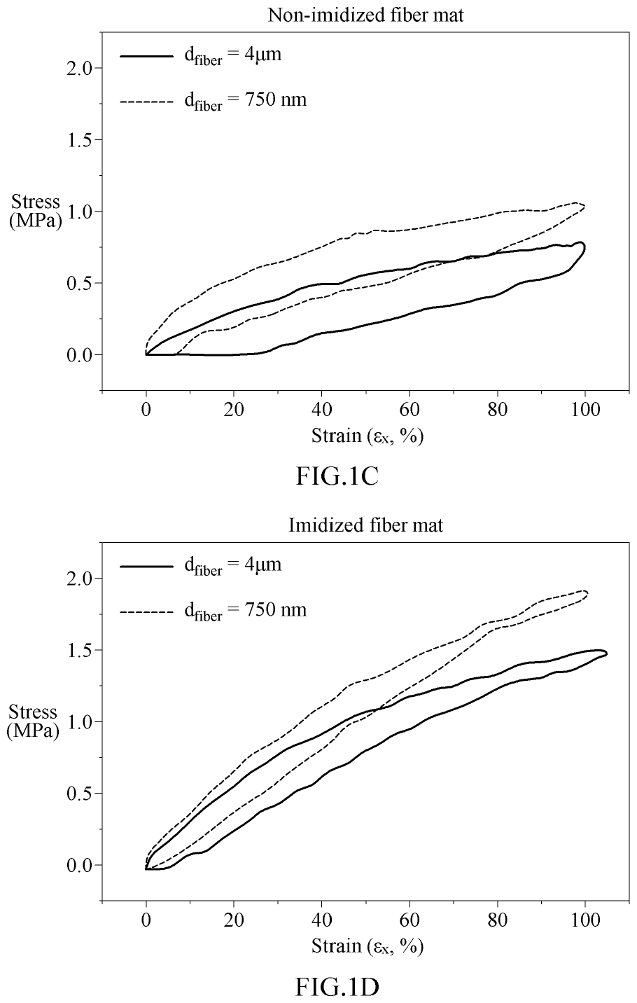

FIG. 1A is a diagram illustrating crosslinking and imidization process of the nanofiber mat when the porous mat including the nanofibers is supported in the polyalkyleneimine solution in operation (a). During the above process, the porous mat including the nanofibers including the polymer swells and the polyalkyleneimine may permeate thereinto, thereby causing crosslinking and imidization of the nanofiber mat.

Further, the method of manufacturing a stretchable electrode may further include, prior to (a), (a′) electrospinning a polymer solution including the polymer to prepare the porous mat including the nanofibers.

Further, the polymer solution may further include at least one selected from a group consisting of an aprotic polar solvent and a non-polar solvent.

Further, the polyalkyleneimine solution may further include a protic polar solvent.

Further, the deposition may be performed by at least one selected from a group consisting of sputtering, thermal evaporation, e-beam evaporation, thermal chemical vapor deposition, plasma enhanced chemical vapor deposition, atmospheric pressure chemical vapor deposition, and low pressure chemical vapor deposition, preferably by using sputtering, thermal evaporation, or e-beam evaporation alone or in combination, and more preferably by sputtering.

Further, the predetermined depth may be controlled by adjusting a deposition time.

According to an example embodiment, there is provided a stretchable electronic device including the stretchable electrode.

Further, the stretchable electronic device may include a stretchable display device, a stretchable light emitting electronic device, a stretchable electronic skin, a stretchable pressure sensor, a stretchable chemical sensor, and a stretchable wearable electronic device.

Further, the stretchable electronic device may include a device attachable to the body and a device implantable in the body.

### Example Embodiments

Hereinafter, preferred example embodiments will be described. However, this is for illustrative purposes, and the scope of the present disclosure is not limited thereto.

### Preparation Example 1: Nanofiber Mat

Polystyrene-block-poly(ethylene butylene)-block-polystyrene grafted with maleic anhydrides (SEBS-g-MA) was dissolved in a solvent mixture of cyclohexane/tetrahydrofuran (THF)/dimethylformamide (DMF) (wt/wt/wt=7:2:1). Here, the concentration of the polymer solution was used as 10 wt %.

The polymer solution was electrospun on a silicon wafer at a fixed feed rate of 20 μL/min and a voltage of 18.0 kV. Here, the distance between the nozzle-collectors was 15 cm, and a 25 G nozzle was used. After collecting a thickness of 80 μm by electrospinning, a nanofiber mat having nanofibers with an average diameter of 4 μm was prepared by peeling off from the silicon wafer.

### Preparation Example 2: Nanofiber Mat

A nanofiber mat was prepared in the same manner as in Preparation Example 1, except that the average diameter of the nanofibers was set to 750 nm by using the concentration of the polymer solution at 7 wt % instead of setting the average diameter of the nanofibers 4 μm by using the concentration of the polymer solution at 10 wt %.

### Preparation Example 3: Nanofiber Mat

A nanofiber mat was prepared in the same manner as in Preparation Example 1, except that the average diameter of the nanofibers was set to 9 μm by using the concentration of the polymer solution at 10 wt % instead of setting the average diameter of the nanofibers 4 μm by using the concentration of the polymer solution at 10 wt %.

### Preparation Example 4: Bulk Film

Polystyrene-block-poly(ethylene butylene)-block-polystyrene grafted with maleic anhydrides (SEBS-g-MA) was dissolved in a solvent mixture of cyclohexane/tetrahydrofuran (THF)/dimethylformamide (DMF) (wt/wt/wt=7:2:1). Here, the concentration of the polymer solution was used as 10 wt %.

The polymer solution was spin-coated on a silicon wafer at 300 rpm for 30 seconds to prepare a 500 μm-thick bulk film.

### Preparation Example 5: Imidized Nanofiber Mat

FIG. 1a is a diagram illustrating crosslinking and imidization process of a nanofiber mat.

Referring to FIG. 1a, the nanofiber mat prepared according to Preparation Example 1 was immersed in a ethanol solution of 10 wt % polyethyleneimine (PEI) at room temperature for 1 hour and at 70° C. for 3 hours. Thereafter, the nanofiber mat was taken out of the solution and sonicated in distilled water for 30 minutes to remove unreacted polyethyleneimine and finally dried at room temperature to prepare an imidized nanofiber mat.

### Preparation Example 6: Imidized Nanofiber Mat

An imidized nanofiber mat was prepared in the same manner as in Preparation Example 5, except that the nanofiber mat prepared according to Preparation Example 2 was used instead of using the nanofiber mat prepared according to Preparation Example 1.

### Preparation Example 7: Imidized Nanofiber Mat

An imidized nanofiber mat was prepared in the same manner as in Preparation Example 5, except that the nanofiber mat prepared according to Preparation Example 3 was used instead of using the nanofiber mat prepared according to Preparation Example 1.

### Preparation 8: Imidized Bulk Film

An imidized bulk film was prepared in the same manner as in Preparation Example 5, except that the bulk film prepared according to Preparation Example 4 was used instead of using the nanofiber mat prepared according to Preparation Example 1.

Table 1 summarizes the nanofiber mats and bulk films prepared according to Preparation Examples 1 to 8.

TABLE 1

| | SEBS- | | Average | | |
|---|---|---|---|---|---|
| | g-MA | | diameter | | |
| | concen- | | of nano- | Thick- | |
| | tration | Preparation | fibers | ness | Imidized |
| Class | (wt %) | method | (μm) | (μm) | or not |
| Preparation | 10 | Electro- | 4 | 80 | — |
| Example 1 | | spinning | | | |
| Preparation | 7 | Electro- | 0.75 | 80 | — |
| Example 2 | | spinning | | | |
| Preparation | 15 | Electro- | 9 | 80 | — |
| Example 3 | | spinning | | | |
| Preparation | 10 | Spin | — | 500 | — |
| Example 4 | | coating | | | |
| Preparation | 10 | Electro- | 4 | 80 | 0 |
| Example 5 | | spinning | | | |
| Preparation | 7 | Electro- | 0.75 | 80 | 0 |
| Example 6 | | spinning | | | |
| Preparation | 15 | Electro- | 9 | 80 | 0 |
| Example 7 | | spinning | | | |
| Preparation | 10 | Spin | — | 500 | 0 |
| Example 8 | | coating | | | |

### Example Embodiment 1: Stretchable Electrode

The imidized nanofiber mat prepared according to Preparation Example 5 was sputtered with Au by DC magnetron sputter (Cressington, 108 Auto). The deposition conditions were 20 mA, 50 sec, and thus, a stretchable electrode in which 1 μm-thick Au was permeated into the nanofiber mat was manufactured.

### Example Embodiment 2: Stretchable Electrode

A stretchable electrode in which 8 μm-thick Au was permeated into was manufactured in the same manner as in Example Embodiment 1, except that Au was deposited under the deposition conditions of 20 mA and 500 seconds instead of to depositing Au under the deposition conditions of 20 mA and 50 sec.

### Example Embodiment 3: A Dog Bone Shaped Stretchable Electrode

The imidized nanofiber mat prepared according to Preparation Example 5 was sputtered with Au by DC magnetron sputter (Cressington, 108 Auto). The deposition conditions were 20 mA, 50 sec and a dog bone shaped stretchable electrode in which 1 μm-thick Au was permeated into the nanofiber mat was manufactured by using two 3 cm×3 cm high conductive pads and a dog bone shaped shadow mask deposited with a width of 1 mm and a length of 1 cm.

### Example Embodiment 4: A Dog Bone Shaped Stretchable Electrode

The imidized nanofiber mat prepared according to Preparation Example 5 was sputtered with Au by DC magnetron sputter (Cressington, 108 Auto). The deposition conditions were 20 mA, 500 sec and a dog bone shaped stretchable electrode in which 8 μm-thick Au was manufactured into the nanofiber mat was prepared by using two 3 cm×3 cm high conductive pads and a dog bone shaped shadow mask deposited with a width of 0.2 mm and a length of 1 cm.

### Comparative Example 1: Electrode

An electrode was manufactured in the same manner as in Example Embodiment 1, except that the nanofiber mat prepared according to Preparation Example 1 was used instead of using the imidized nanofiber mat prepared according to Preparation Example 5.

### TEST EXAMPLES

### Test Example 1: Average Diameter of Nanofibers in Nanofiber Mats

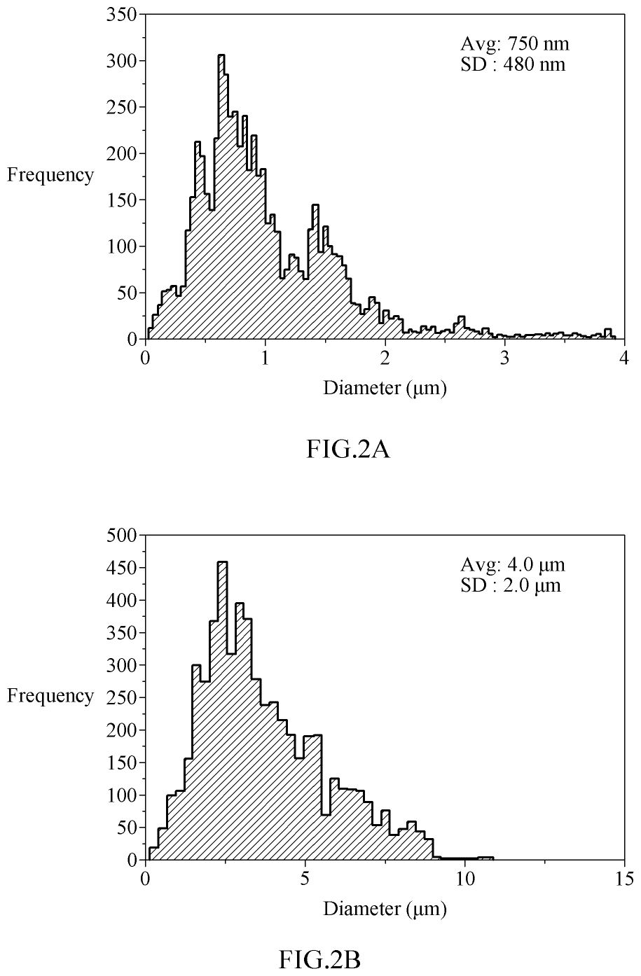

FIG. 2A is a diagram illustrating the average diameter of the nanofibers in the nanofiber mat of Preparation Example 1, and FIG. 2B is a diagram illustrating the average diameter of the nanofibers in the nanofiber mat of Preparation Example 5.

Referring to FIGS. 2A and 2B, it may be confirmed that when the maleic anhydride-grafted styrene-ethylene-butylene-styrene copolymer (SEBS-g-MA) is present at a concentration of 7 wt % in the solvent mixture during electrospinning, nanofibers having an average diameter of 750 nm were prepared, and when present at a concentration of 10 wt %, nanofibers having an average diameter of 4.0 μm were prepared.

### Test Example 2: Confirmation of the Reaction Between SEBS-g-MA and PEI

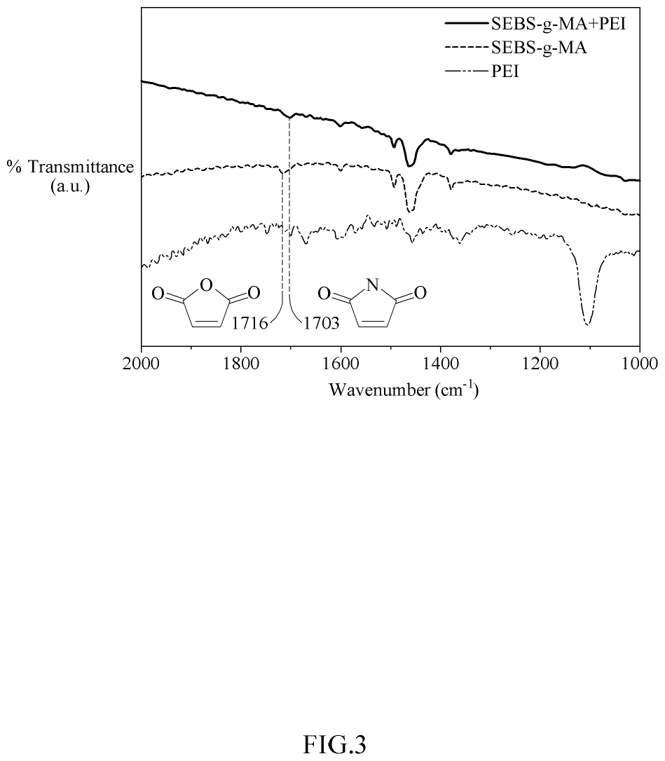

FIG. 1B is a diagram illustrating a result of molecular weight measurement of Preparation Example 1 and Preparation Example 5, and FIG. 3 is a diagram illustrating a result of FT-IR analysis of Preparation Example 1, Preparation Example 5 and PEI.

Referring to FIG. 1B, it may be confirmed that a peak is additionally generated in Preparation Example 5 (SEBS-g-MA+PEI) compared to Preparation Example 1 (SEBS-g-MA), and it is shown that the peak indicated by (a) has a value of M_{w}=257,000, poly diversity index (PDI)=1.05, the peak indicated by (b) has a value of M_{w}=134,000, PDI=1.03, and unreacted SEBS-g-MA has a value of M_{w}=59,000. Therefore, it may be confirmed that the molecular weight of SEBS-g-MA after the reaction with PEI is increased compared to before the reaction.

Referring to FIG. 3, it may be confirmed that the peak of the carboxyl group which was detected at 1716 cm⁻¹ in Preparation Example 1 (SEBS-g-MA), was detected at 1703 cm⁻¹ in Preparation Example 5 (SEBS-g-MA+PEI). This indicates that as SEBS-g-MA reacted with PEI, the peak of the carboxyl group shifted and changed to the peak corresponding to the imide group.

### Test Example 3: Tensile Strength Test of Nanofiber Mats

FIG. 1C is a diagram illustrating a Stress-Strain graph upon uniaxial tension of Preparation Examples 1 and 2, and FIG. 1D is a diagram illustrating a Stress-Strain graph upon uniaxial tension of Preparation Example 5 and Preparation Example 6.

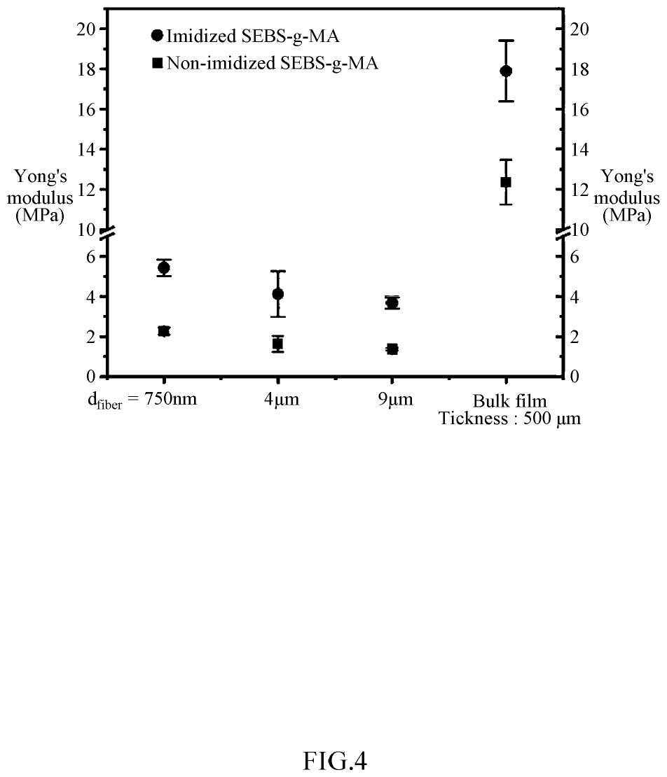

FIG. 4 is a diagram illustrating a graph of Young's modulus values of Preparation Examples 1 to 8.

Referring to FIGS. 1C and 1D, it may be confirmed that the nanofiber mat exhibits elastic behavior up to 100% of Strain (c) upon uniaxial tension regardless of imidization.

Referring to FIG. 4, it may be confirmed that the Young's modulus (E₀) of Preparation Example 1 (d_{fiber}=4 μm) is 1.63 MPa, whereas the Young's modulus (E₀) of Preparation Example 2 (d_{fiber}=750 nm) is 2.27 MPa. Further, it may be confirmed that the Young's modulus (E₀) of the imidized nanofiber mat is 4.11 MPa in Preparation Example 5 (d_{fiber}=4 μm) and 5.42 MPa in Preparation Example 6 (d_{fiber}=750 nm), respectively. Furthermore, in the case of Preparation Example 4 and Preparation Example 8, which are bulk films, 12.35 MPa and 17.89 MPa, respectively, were exhibited.

Therefore, it may be confirmed that the Young's modulus (E₀) is increased after the nanofiber mat is imidized.

### Test Example 4: Analysis of Mechanical Behavior of Nanofiber Mats

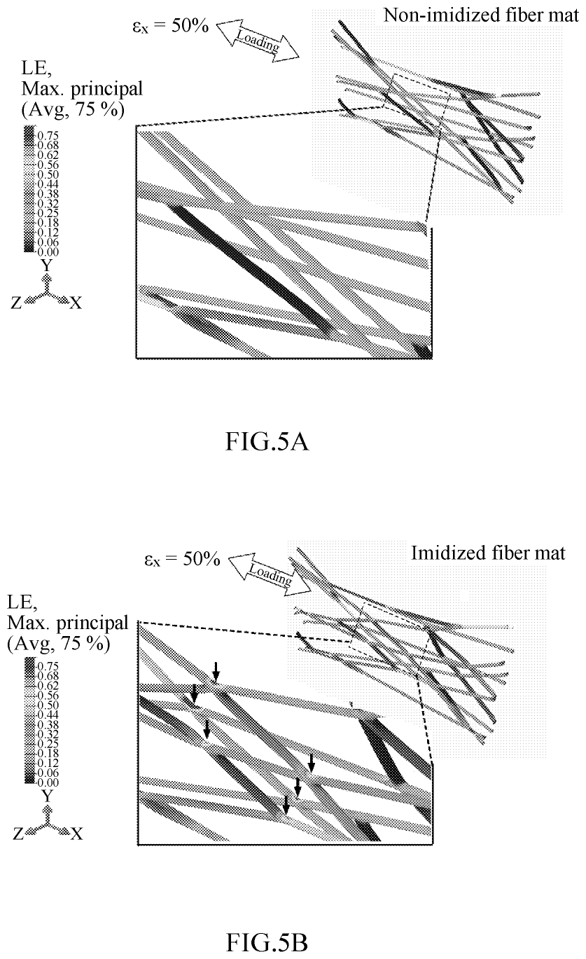

FIG. 5A is a diagram illustrating a result of mechanical behavior analysis through FEM simulation of Preparation Example 1, and FIG. 5B is a diagram illustrating a result of mechanical behavior analysis through FEM simulation of Preparation Example 5. Specifically, the strain distribution in the 50% tensile state (εₓ=50%) in uniaxial tension is illustrated.

Referring to FIGS. 5A and 5B, it may be confirmed that in Preparation Example 1 which is non-imidized, since no chemical crosslinking between the fibers occurred, the fibers did not bond with each other. Due to this, it may be confirmed that the fibers are aligned in the tensile direction according to the tension, and the strain caused by the deformation is uniformly distributed in the fibers.

On the other hand, in Preparation Example 5 which is imidized, the fibers are aligned in the tensile direction at the initial stage of tension, and the bonding part of the fibers acts as a deformation constraint which prevents alignment, and high strain is concentrated in this part. Therefore, the result shows that the strain according to the deformation is distributed high in the fiber bonding part and relatively low in the other parts.

### Test Example 5: Metal Layer Fracture Behavior Upon Deformation for Metal Deposition Depending on Whether Imidized or not

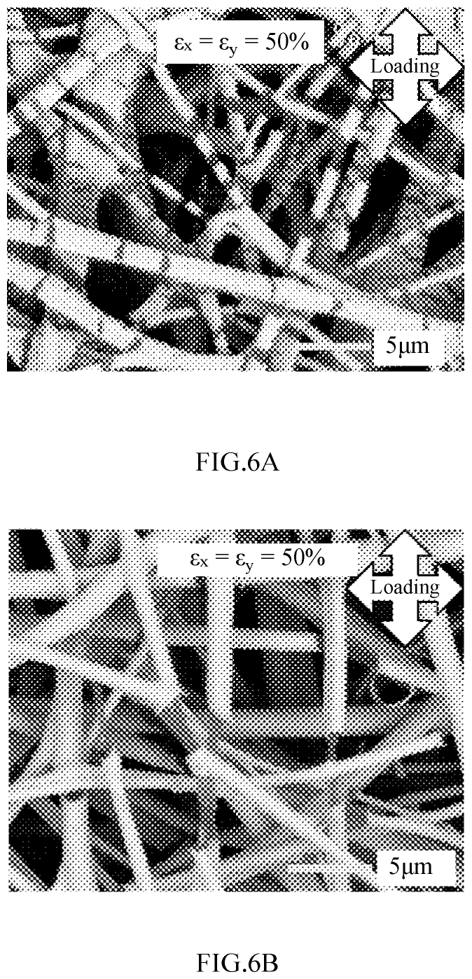

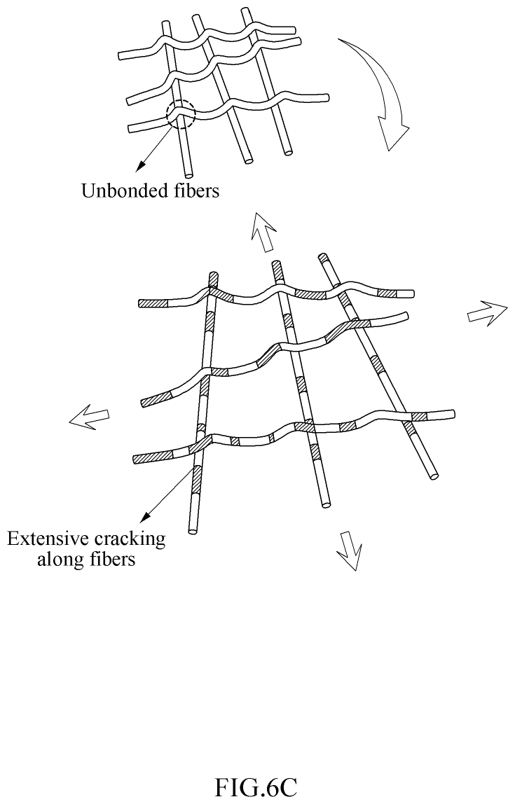

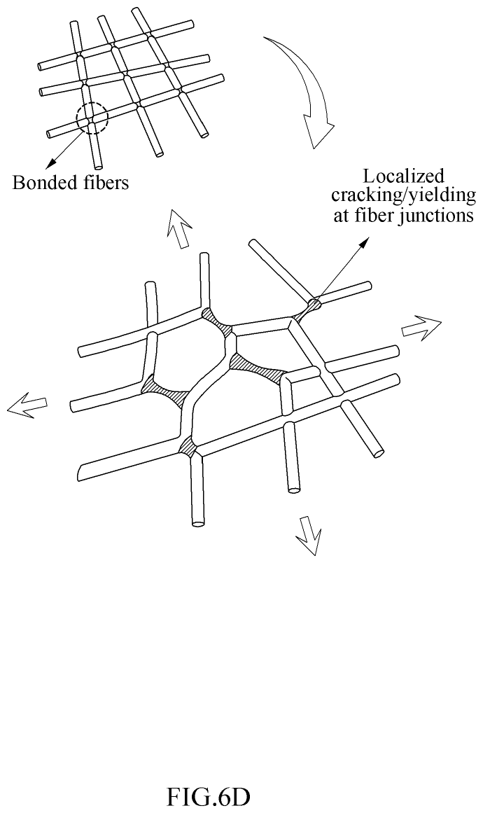

FIG. 6A is a diagram illustrating an SEM image of Comparative Example 1 upon biaxial tension, and FIG. 6B is a diagram illustrating an SEM image of Example Embodiment 1 upon biaxial tension. FIG. 6C is a diagram illustrating a simulation of Au cracking upon biaxial tension of Comparative Example 1, and FIG. 6D is a diagram illustrating a simulation of Au cracking upon biaxial tension of Example Embodiment 1. Here, the biaxial tension was carried out at εₓ=ε_{y}=50%.

Referring to FIGS. 6A to 6D, in the case of Comparative Example 1 which is non-imidized, as described above, since the strain is uniformly distributed, this strain is transferred to the metal layer to form a cracking layer in a wide area on the fiber. In contrast, in the case of Example Embodiment 1 which is imidized, it may be confirmed that since the strain is highly distributed at the fiber junctions, crackings selectively occur in the metal layer located in this area. Since the area where crackings are concentrated has a relatively low modulus compared to the area where crackings are not concentrated, the strain is concentrated for additional deformation, and since fiber yielding proceeds in this area and the metal layer of other areas maintains its shape, the metal layer may maintain a continuous network structure. Since these nanofiber mats are stacked on each other, a three-dimensional continuous conductive network may be formed.

### Test Example 6: Metal Deposition Characteristics of Nanofiber Mats

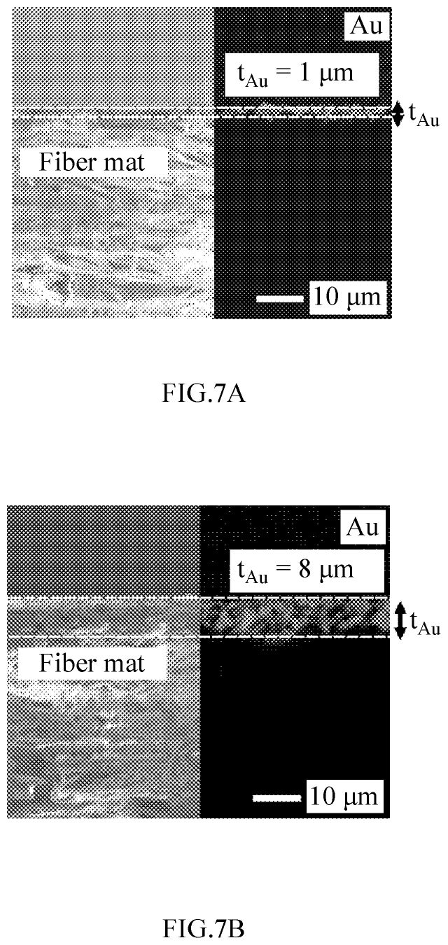

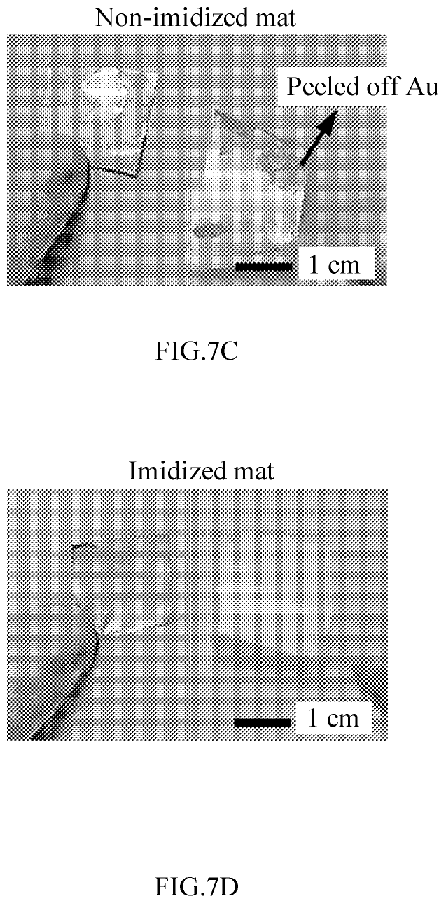

FIG. 7A is a diagram illustrating a cross-sectional SEM image of Example Embodiment 1, and FIG. 7B is a diagram illustrating a cross-sectional SEM image of Example Embodiment 2. FIG. 7C is a diagram illustrating a result image when Comparative Example 1 was peeled off with a scotch tape, and FIG. 7D is a diagram illustrating a result image when Example Embodiment 1 was peeled off with a scotch tape.

Referring to FIGS. 7A and 7B, it may be confirmed that the metal layer permeates in the depth direction of the nanofiber mat according to the metal deposition time. Specifically, it may be confirmed that the permeation thickness (t_{Au}) in the nanofiber mat is 1 μm in Example Embodiment 1 with a deposition condition of 50 sec, and the permeation thickness (t_{Au}) in the nanofiber mat is 8 μm in Example Embodiment 2 with a deposition condition of 500 sec.

Referring to FIGS. 7C and 7D, in Comparative Example 1 which is non-imidized, it may be confirmed that the metal layer was peeled off from the adhesive layer of the scotch tape. On the other hand, in Example Embodiment 1 which is imidized, it may be confirmed that the metal layer was not peeled off even when the scotch tape is repeatedly adhered This is because the metal layer is well attached to the nanofiber mat due to the high electrostatic attraction between the unbound amine group of PEI bound to SEBS-g-MA and the metal layer (Au).

### Test Example 7: Characteristics Due to Including Thermoplastic Polymer Film

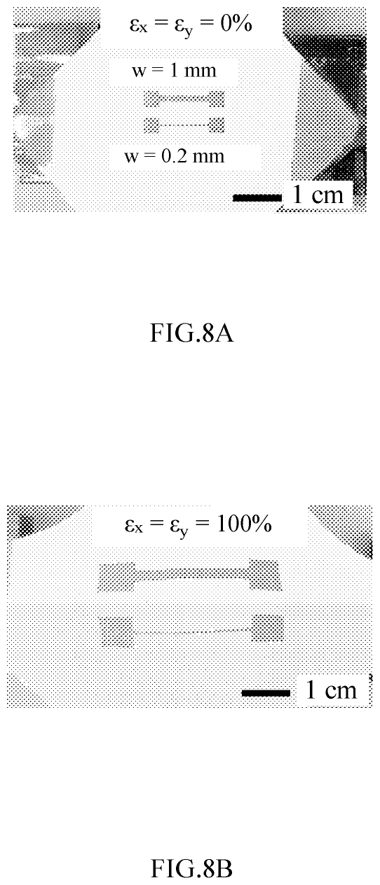

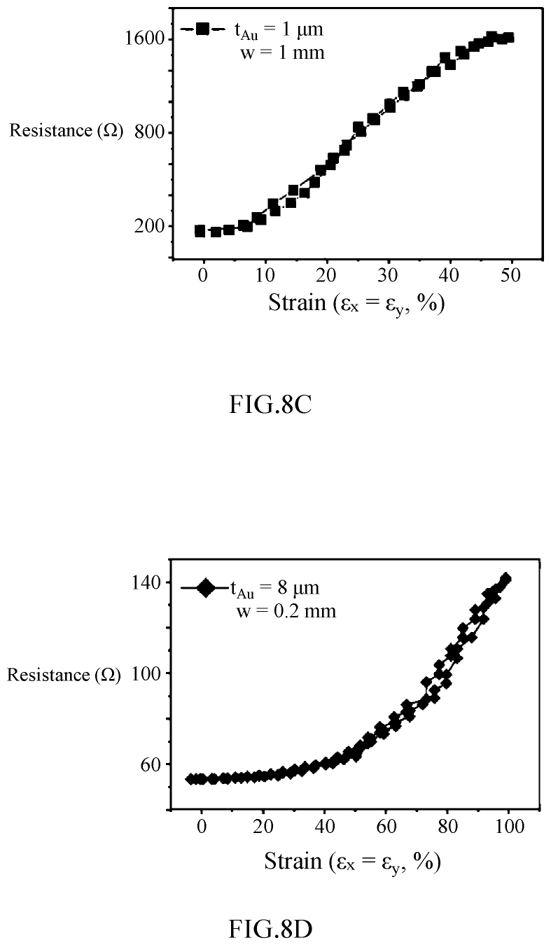

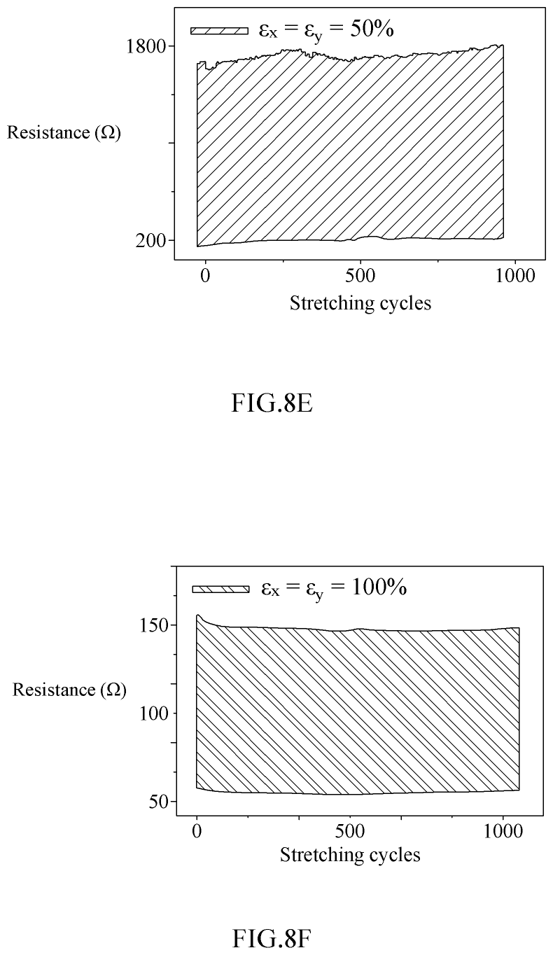

FIG. 8A is a diagram illustrating images of Example Embodiment 3 and Example Embodiment 4, and FIG. 8B is a diagram illustrating images of Example Embodiment 3 and Example Embodiment 4 upon biaxial tension (εₓ=ε_{y}=100%). FIG. 8C is a diagram illustrating a result of the conductivity change measurement during biaxial tension (εₓ=ε_{y}=50%) of Example Embodiment 3, and FIG. 8D is a diagram illustrating a result of the conductivity change measurement during biaxial tension (εₓ=ε_{y}=100%) of Example Embodiment 4. FIG. 8E is a diagram illustrating the result of the conductivity change measurement when the biaxial tension (εₓ=ε_{y}=50%) of Example Embodiment 3 was repeated 1,000 times and deformed, and FIG. 8F is a diagram illustrating the result of the conductivity change measurement when the biaxial tension (εₓ=ε_{y}=100%) of Example Embodiment 4 was repeated 1,000 times and deformed.

Referring to FIG. 8C, it may be found that Example Embodiment 3 follows the same change curve before and after deformation, and the elasticity of the nanofiber mat contributes to the repeatable change in conductivity.

Referring to FIG. 8D, it may be found that in Example Embodiment 4, the resistance change changes relatively insensitively to deformation due to the deep deposition thickness, and as in Example Embodiment 3, it may be confirmed to follow the same resistance change curve during deformation and repetitive deformation occurs, due to the nanofiber mat having high elasticity.

Referring to FIGS. 8E and 8F, it may be confirmed that both Example Embodiments 3 and 4 maintain constant initial resistance values and have similar resistance values even in the maximum deformation state. Therefore, it may be confirmed that the stretchable electrode according to the example embodiments has the characteristics of a conductor with high durability and reliability.

Therefore, the scope of the disclosure is defined not by the detailed description, but by the claims and their equivalents, and all variations within the scope of the claims and their equivalents are to be construed as being included in the disclosure.

1. A stretchable electrode comprising a conductive mat,
wherein the conductive mat comprises:
nanofibers comprising a polymer; and
a conductive layer formed on surfaces of the nanofibers and comprising a conductor.

2. The stretchable electrode of claim 1, further comprising a base mat on the conductive mat,
wherein the base mat comprises nanofibers comprising a polymer.

3. The stretchable electrode of claim 1 or 2, wherein the conductive mat and the base mat each independently further comprises a polyalkyleneimine obtained by crosslinking the polymer.

4. The stretchable electrode of claim 3, wherein the crosslinking each independently comprises at least one selected from a group consisting of inter-crosslinking which crosslinks surfaces of nanofibers with each other and intra-crosslinking which crosslinks the polymer within a single nanofiber.

5. The stretchable electrode of claim 3, wherein the conductive mat and the base mat are bonded, and
the bonding is by at least one selected from a group consisting of sharing of a part of the polymer of the conductive mat and a part of the polymer of the base mat, and crosslinking between the polymer of the conductive mat and the polymer of the base mat.

6. The stretchable electrode of claim 3, wherein the polyalkyleneimines are the same or different from each other, and each independently comprises at least one selected from a group consisting of linear polyalkyleneimine, comb polyalkyleneimine, branched polyalkyleneimine, and dendrimer polyalkyleneimine.

7. The stretchable electrode of claim 3, wherein the polyalkyleneimines are the same or different from each other, and each independently comprises at least one selected from a group consisting of polyethyleneimine and polypropyleneimine.

8. The stretchable electrode of claim 2, wherein the polymer is an elastic body.

9. The stretchable electrode of claim 7, wherein the polymers are the same or different from each other, and each independently comprises at least one selected from a group consisting of styrene-butadiene-styrene block copolymer (SBS), styrene-isoprene-styrene block copolymer (SIS), styrene-ethylene-butylene-styrene block copolymer (SEBS), styrene-butadiene block copolymer (SBR), styrene-ethylene-propylene-styrene block copolymer (SEPS), styrene-methyl methacrylate copolymer (PSMMA), styrene-acrylonitrile copolymer (PSAN), polyurethane, silicone rubber, and butadiene rubber.

10. The stretchable electrode of claim 9, wherein the polymer further comprises an organic acid anhydride grafted to a main chain.

11. The stretchable electrode of claim 10, wherein the organic acid anhydride comprises at least one selected from a group consisting of maleic anhydride, succinic anhydride, acetic anhydride, Naphthalenetetracarboxylic dianhydride, and ethanoic anhydride.

12. The stretchable electrode of claim 1, wherein the conductor comprises at least one selected from a group consisting of gold, silver, copper, platinum palladium, nickel, indium, aluminum, iron, rhodium, ruthenium, osmium, cobalt, molybdenum, zinc, vanadium, tungsten, titanium, manganese, chromium, graphene, and carbon nano tube (CNT).

13. The stretchable electrode of claim 1, wherein a thickness of the conductive mat is 0.01 to 100 μm, and a thickness of the base mat is 0.1 to 1000 μm.

14. The stretchable electrode of claim 2, wherein each of the conductive mat and the base mat is porous.

15. A method of manufacturing a stretchable electrode, the method comprising:
(a) preparing a porous mat comprising a polymer crosslinked with a polyalkyleneimine by supporting, swelling, and crosslinking a porous mat comprising nanofibers comprising a polymer in a polyalkyleneimine solution; and
(b) depositing a conductor to a predetermined depth of the porous mat to form a conductive layer on surfaces of nanofibers.

16. The method of claim 15, further comprising:
prior to (a), (a′) electrospinning a polymer solution comprising the polymer to prepare the porous mat comprising the nanofibers.

17. The method of claim 16, wherein the polymer solution further comprises at least one selected from a group consisting of an aprotic polar solvent and a non-polar solvent.

18. The method of claim 15, wherein the polyalkyleneimine solution further comprises a protic polar solvent.

19. The method of claim 15, wherein the predetermined depth is controlled by adjusting a deposition time.

20. A stretchable electronic device comprising the stretchable electrode of claim 1.
